(19) United States
(12) Patent Application Publication
(10) Pub. No.: US 2020/0001514 A1
(43) Pub. Date: Jan. 2, 2020

(54) MOULDING AND FILLING STATION OF AN INSTALLATION FOR PRODUCING FILLED CONTAINERS FROM PREFORMS BY MEANS OF FILLING MATERIAL INTRODUCED INTO THE PREFORM UNDER PRESSURE

(71) Applicant: KHS CORPOPLAST GmbH, Hamburg (DE)

(72) Inventors: Michael LITZENBERG, Börnsen (DE); Michael LINKE, Hamburg (DE); Gerhard KLÖPPER, Hamburg (DE)

(21) Appl. No.: 16/314,213

(22) PCT Filed: Jul. 13, 2017
(86) PCT No.: PCT/EP2017/000832

§ 371 Date: Dec. 28, 2018

(30) Foreign Application Priority Data
Jul. 29, 2016 (DE) 102016009208.4

(51) Int. Cl. B29C 49/06; B29C 49/12

(52) U.S. Cl. CPC B29C 49/06; B29C 49/78; B29C 49/12

(57) ABSTRACT

The invention relates to a moulding and filling station of an installation for producing filled containers from preforms (2) by means of liquid filling material introduced into the preform (2) under pressure, said moulding and filling station comprising a stretch rod (1) and a liquid duct (3), which can be controlled by means of a filling valve (22), passes through at least part of the stretch rod (1) and ends in at least one outlet opening (4a, 4b, 4c, 4d, 5) in the stretch rod (1), and being characterised in that a gas barrier (6, 6a, 6b) is provided in the liquid duct (3) between the filling valve (22) and the outlet opening (4a, 4b, 4c, 4d, 5). The invention also relates to a stretch rod (1) for a moulding and filling station, having a filling material duct (3) and at least one outlet opening (4a, 4b, 4c, 4d, 5) for discharging filling material, a gas barrier (6, 6a, 6b) being provided in the filling material duct (3).

The present invention relates to a molding and filling station of an installation for producing filled containers from preforms by means of liquid filling material introduced into the preform under pressure as well as a stretch rod for such a molding and filling station.

Containers, in particular bottles, are traditionally shaped in the blow-molding process by means of a molding gas introduced under pressure into a preheated preform and then, in a second step, are filled with a filling material, in particular a liquid filling material. Methods have recently been developed for a more economical production, in which the preheated preform is not molded and filled by a compressed gas but instead is molded in one step by the liquid filling material, which is supplied under pressure. Such a method is known from DE 10 2010 007 541 A1.

In order for a preform to be remolded into a container, it is thermally conditioned, i.e., heated in particular, and provided with a suitable temperature profile. In doing so, the body of the preform is heated to approx. 120° C., for example, and can be shaped while the mouth area is only allowed to reach much lower temperatures because the preform is held at the mouth area in the molding and filling machine and must not be allowed to be deformed under the holding forces that typically prevail there. For the thermal conditioning, an apparatus for producing filled containers usually has a heating zone, along which the preforms are guided and are thereby provided with the desired temperature profile.

The molding process must then proceed very rapidly in order for the heat stored in the preform to be sufficient to keep the preform in a plastic moldable condition until the end of the molding process. When using liquid filling material during molding, the volume required for the fully molded container must be supplied to the preform under a high pressure and within a short period of time.

The preform must also be guided while being molded into a container, so that uniform and controlled molding can take place. This can be accomplished with a stretch rod, which executes a movement in the direction of the longitudinal axis of the container during the molding and filling operation and thereby triggers the molding process through pressure on the bottom of the preform and then controls the molding through contact with the bottom area.

It is advisable to supply the filling material through the stretch rod. The stretch rod to be inserted into the interior of the preform through the mouth of the preform and then into its interior limits the cross section of the stretch rod that is available for any supply of filling material to such an extent that it seems appropriate to supply it through the stretch rod. On the other hand, the filling material can be supplied through the stretch rod at different locations on the preform and/or the container being molded, and an advantageous flow can be achieved through skillful positioning of the outlet openings.

However, when using a stretch rod after the end of the molding and filling operation, filling material may subsequently drip out of the stretch rod. The filling valve with which the flow of filling material is controlled is normally, for practical reasons, arranged in the molding and filling head upstream from the stretch rod, so that the volume of filling material downstream from it can easily run out of the stretch rod. It is already known from DE 10 2010 007 541 A1 that subsequent dripping of filling medium can be minimized by mechanical means by providing a nonreturn valve in the flow path for the filling medium. This nonreturn valve closes under spring force as soon as the spring force exceeds the flow pressure of the filling material on the nonreturn element of the nonreturn valve.

Subsequent dripping of filling material results in contamination of the molding and filling station and loss of filling material. Furthermore, the molding and filling station is not immediately ready for use at full pressure. After the filling valve has been opened, the stretch rod volume must first be supplied with filling material. The air therein must first be displaced before the full hydraulic pressure can be built up by the filling material.

The object of the present invention is to improve upon a molding and filling station of an installation for manufacturing filled containers from preforms by means of liquid filling material introduced into the preform under pressure, comprising a stretch rod, such that there are no losses of filling material due to filling material subsequently dripping out of the stretch rod.

This object is achieved according to the invention by a molding and filling station of an installation for manufacturing filled containers from preforms by means of a liquid filling material introduced into the preform under pressure, comprising a stretch rod and a liquid duct, which can be controlled by a filling valve and passes at least partially through the stretch rod, ending in at least one outlet opening arranged in the stretch rod, characterized in that a gas barrier is provided between the filling valve and the outlet opening in the liquid duct.

A gas barrier is an element arranged in the liquid duct, preventing air from being able to penetrate into the portion of the liquid duct upstream from the gas barrier due to suitable dimensioning or division of the free flow cross section of the liquid duct. In contrast with the nonreturn valve according to DE 10 2010 007 541 A1, mechanical closing of the flow path is not necessary when using such a gas barrier. A gas barrier is based on the finding that a liquid in a line without pressure will no longer run out of the line due to its surface tension in interaction with the ambient pressure as long as the outlet opening in the line is small enough. Surface tension will then prevent droplets from forming. The barrier effect of the gas barrier is thus based solely on the surface tension of the liquid.

A gas barrier may therefore consist of a plurality of sieve ducts or flow ducts, for example, dividing the total cross section of the duct into a plurality of smaller cross sections, so that each individual cross section is small enough to achieve the desired effect.

The gas barrier may have round or polygonal cross-sectional areas, in particular triangular or hexagonal cross-sectional areas.

The gas barrier may form ducts with a coaxial arrangement in the stretch rod. The length of a duct here is preferably greater than the diameter of its cross-sectional area.

Which dimensions and ratios between the duct diameter and duct length are suitable depends to a significant extent on the filling material and its surface tension. Those skilled in the art can easily determine suitable dimensions either theoretically or experimentally.

The gas barrier is advantageously arranged directly upstream from the outlet opening of the flow duct. “Directly” here should mean that the volume of liquid remaining between the gas barrier and the outlet opening is negligible. The filling material which might still escape from the stretch rod can be minimized in this way.

The stretch rod of a molding and filling station according to the invention may also have a plurality of outlet openings. The outlet openings may be arranged at the same level in the flow duct, comprising, for example, there may be a plurality of radial openings in the stretch rod or at different levels, so that filling material can be introduced into the preform at different levels during the molding and filling operation. A gas barrier should then preferably be arranged upstream from each outlet opening. It may be a joint gas barrier for a plurality of outlet openings situated in close spatial proximity to one another or individual gas barriers, each arranged upstream from the respective outlet opening.

The object according to the invention is also achieved by a stretch rod for a molding and filling station as described above, having a filling material duct and at least one outlet opening for discharge of filling material, characterized in that a gas barrier is arranged in the filling material duct.

The gas barrier preferably divides the cross section of the liquid duct into a plurality of cross-sectional areas. It may have round or polygonal cross-sectional areas, in particular triangular or hexagonal cross-sectional areas.

The gas barrier may form ducts having a coaxial arrangement in the stretch rod. The length of a duct is preferably greater than the diameter of its cross-sectional area.

The gas barrier may be arranged directly upstream from the outlet opening. The stretch rod may also have a plurality of outlet openings at different positions in the flow duct, and a gas barrier may be provided upstream from each outlet opening.

Various embodiments of stretch rods according to the invention are explained in greater detail below on the basis of the accompanying illustrations which show the following:

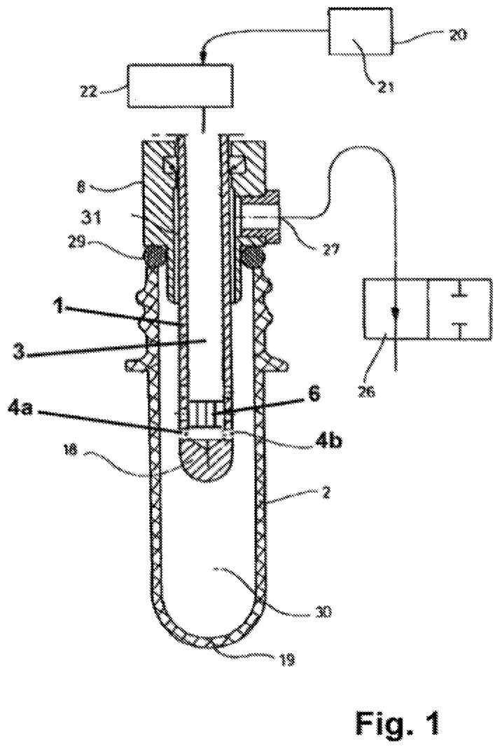

FIG. 1 shows schematically the elements of a molding and filling station in the context of a machine for simultaneous molding and filling of containers;

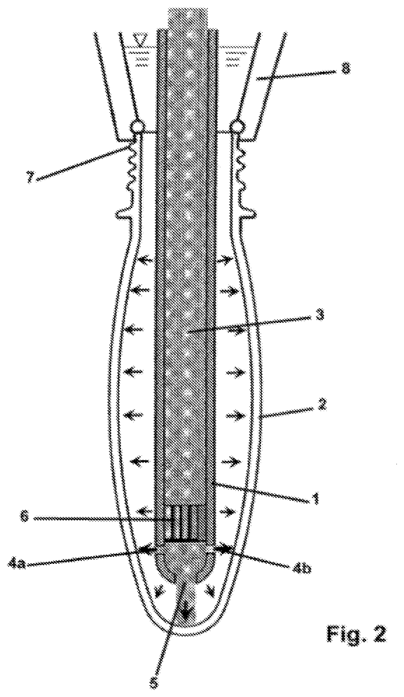

FIG. 2 shows a sectional view of a stretch rod during according to the invention simultaneous molding and filling of a preform to form a container in a sectional view;

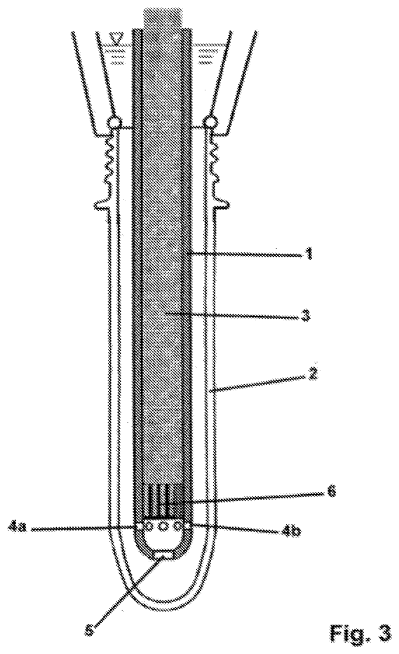

FIG. 3 shows a sectional view of the stretch rod from FIG. 1 at the start of a molding and filling operation in a pressureless state;

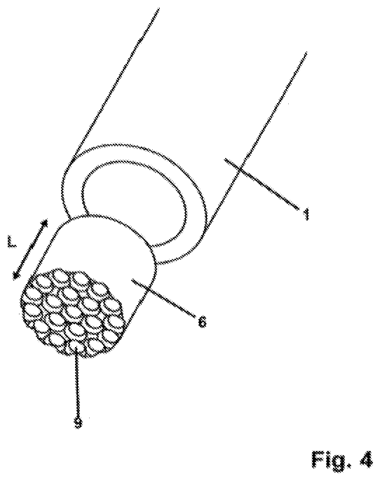

FIG. 4 shows a perspective partially cutaway diagram of a stretch rod according to the invention with a gas barrier;

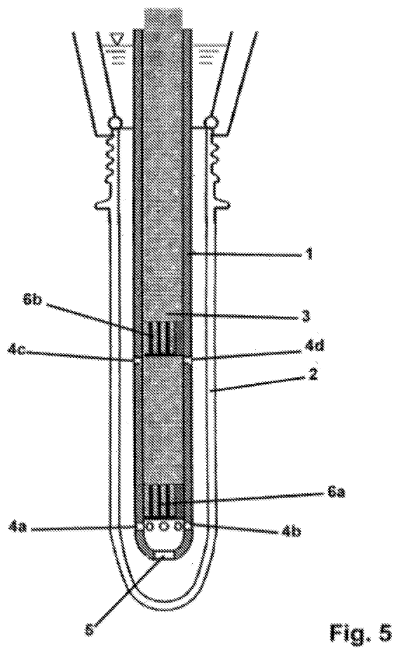

FIG. 5 shows a stretch rod like that in FIG. 1, wherein the stretch rod has a plurality of outlet openings at different levels.

All the diagrams are understood to be illustrations of the principle of the invention. They are also represented in simplified form in some cases and include only the components required to illustrate the invention. Based on their technical knowledge, those skilled in the art can readily vary the size ratios of the individual components to one another or adjust them to specific needs.

FIG. 1 shows a longitudinal section through a preform 2 into which a stretch rod 1 is inserted. The stretch rod 1 serves to guide the preform 2 at least temporarily while it is being reshaped to form the container. Typically there is contact between the tip 18 of the stretch rod 1 and the bottom 19 of the preform 2. Further insertion of the stretch rod 1 into the preform 2 causes longitudinal stretching of the preform 2. After the end of the stretching operation or even while the stretching operation is being carried out, filling material 21 taken from a storage device 20 is introduced into the preform 2 through the liquid duct 3 in the interior of the stretch rod 1. The liquid stream can be controlled by the filling valve 22.

The preform 2 can be ventilated by using a vent valve 26. The vent valve 26 is connected to an outflow opening 27 arranged in the area of a molding and filling head 8 acting on the preform 2. The stretch rod 1 can be positioned by means of the molding and filling head 8. The preform 2 is sealed with respect to the molding and filling head 28 by a gasket 29, which may be designed as an 0-ring, for example. An interior space 30 of the preform 2 can be connected by an annular gap 31 to the outflow opening 27. The annular gap 31 thereby encloses the stretch rod 1 in some areas.

With the filling valve open, the filling material can flow through the outlet openings 4a, 4b into the preform 2. According to the invention, a gas barrier 6 is arranged upstream from the outlet openings.

FIG. 2 shows a stretch rod 1 according to the invention in a sectional view during the simultaneous molding and filling of a preform 2 to form a container. The molding and filling head 8 of a molding and filling station of an apparatus for simultaneous molding and filling of bottles from preforms is placed on the mouth 7 of the preform. The preform 2 is in a mold (not shown here) which defines the shape of the bottle to be molded.

A liquid duct 3 through which filling material can be introduced into the preform 2 under a high pressure is situated in the interior of the stretch rod 1. To this end, the filling valve (not shown in this figure), which is situated above the stretch rod in the liquid stream, is opened. Filling material is introduced through the outlet openings 4a, 4b and 5 into the preform 2. The pressure prevailing in the preform ensures the shaping to form a container, as indicated by the arrows.

A gas barrier 6 is situated directly upstream from outlet openings 4a, 4b and 5.

FIG. 3 illustrates the same arrangement as in FIG. 1, but at the start of a molding and filling operation. The stretch rod 1 is already inserted into the preform 2 but is still pressureless because the filling valve (not shown) is not yet closed. The gas barrier 6 prevents the filling material present in the liquid duct 3 from flowing through the outlet openings 4a, 4b, 5 into the stretch rod as long as the station is pressureless.

To this end, as illustrated in FIG. 4, a gas barrier 6 may be arranged in the stretch rod 1, which is illustrated here in a partially cutaway view. The gas barrier 6 consists of a plurality of ducts 9 each having a round cross section and a length L corresponding to a multiple of the duct diameter. Which dimensions and ratios between the duct diameter and duct length L are suitable depends to a significant extent on the filling material and its surface tension. Those skilled in the art can easily ascertain suitable dimensions theoretically or experimentally.

FIG. 5 shows a stretch rod 1 like that in FIG. 1, where the stretch rod has a plurality of outlet openings 4a, 4b, 5 and 4c, 4d at different levels. In this way, the filling material can be introduced at different levels into the container being molded. A gas barrier 6a is thus located directly upstream from the lower outlet openings 4a, 4b, 5 as well as upstream from the upper outlet openings 4c, 4d. The upper gas barrier 6b prevents filling material from running out of the liquid duct in the stretch rod from above when the liquid has flowed out after closing the filling valve beneath the gas barrier 6b through the outlet openings 4c, 4d and there is a small unfilled region in the stretch rod in the area of the upper outlet openings 4c, 4d.

1-14. (canceled)

15: A molding and filling station of an installation for producing a filled container from a preform by introducing a liquid filling material under pressure into the preform, the molding and filling station comprising:
a stretch rod;
a liquid duct that passes at least partially through the, stretch rod; and
a filling valve for controlling a flow of the liquid filling material through the liquid duct;
wherein at least one outlet opening is provided in an end portion of the stretch rod, and
wherein a gas barrier is disposed in the liquid duct between the filling valve and the at least one outlet opening.

16: The molding and filling station according to claim 15, wherein the gas barrier comprises an insert provided with a plurality of flow passages, and wherein each said plurality of flow passages has a cross-sectional area that is smaller than a cross-sectional area of the liquid duct.

17: The molding and filling station according to claim 16, wherein the plurality of flow passages in the gas barrier are round or polygonal in cross-section.

18: The molding and filling station according to claim 16, wherein the plurality of flow passages in the gas barrier are triangular or hexagonal in cross-section.

19: The molding and filling station according to claim 16, wherein some of the plurality of flow passages in the gas barrier are arranged in rings that are coaxial relative to each other and to the stretch rod.

20: The molding and filling station according to claim 19, wherein each of the plurality of flow passages through the gas barrier has a length that is greater than the cross-sectional area of said flow passage.

21: The molding and filling station according to claim 15, wherein the gas barrier is disposed in the liquid duct directly upstream from the at least one outlet opening disposed in the end portion of the stretch rod.

22: The molding and filling station according to claim 15, wherein at least one further outlet opening is provided in the stretch rod other than in the end portion, and wherein a further gas barrier is disposed upstream from the at least one further outlet opening.

23: A stretch rod for use in a molding and filling station of an installation for producing a filled container from a preform by introducing a liquid filling material, said stretch rod comprising a filling material duct that passes at least partially through the stretch rod, wherein at least one outlet opening is provided in an end portion of the stretch rod for the discharge of filling material, and wherein a gas barrier is disposed in the filling material duct.

24: The stretch rod according to claim 23, wherein the gas barrier comprises an insert provided with a plurality of flow passages, and wherein each of said plurality of flow passages has a cross-sectional area that is smaller than a cross-sectional area of the filling material duct.

25: The stretch rod according to claim 24, wherein the plurality of flow passages in the gas barrier are round or polygonal in cross-section.

26: The stretch rod according to claim 25, wherein the plurality of flow passages in the gas barrier are triangular or hexagonal in cross-section.

27: The stretch rod according to claim 23, wherein some of the plurality of flow passages in the gas barrier are arranged in rings that are coaxial relative to each other and the stretch rod.

28: The stretch rod according to claim 27, wherein each of the plurality of flow passages through the gas barrier has a length that is greater than the cross-sectional area of said flow passage.

29: The stretch rod according to claim 23, wherein the gas barrier is disposed in the liquid duct directly upstream from the at least one outlet opening disposed in the end portion of the stretch rod.

30: The stretch rod according to claim 23, wherein at least one further outlet opening is provided in the stretch rod other than in the end portion, and, wherein a further gas barrier is disposed in the filling material duct upstream from the at least one further outlet opening.
